(19) United States
(12) Patent Application Publication
(10) Pub. No.: US 2005/0150108 A1
(43) Pub. Date: Jul. 14, 2005

(54) Heat carrier and method for the production thereof

(75) Inventors: Walter Demuth, Gerlingen (DE); Martin Kotsch, Ludwigsburg (DE); Karl-Heinz Staffa, Stuttgart (DE); Christoph Walter, Stuttgart (DE)

Correspondence Address: FOLEY AND LARDNER;SUITE 500, 3000 K STREET NW, WASHINGTON, DC, 20007, US

(73) Assignee: BEHR GMBH & CO. KG

(21) Appl. No.: 10/513,415

(22) PCT Filed: May 7, 2003
(86) PCT No.: PCT/EP03/04762

(30) Foreign Application Priority Data
May 15, 2002 (DE) 102 21 457.3

(51) Int. Cl. C03B 13/14; C03B 19/10

(52) U.S. Cl. 29/890.038; 65/143

(57) ABSTRACT

The invention relates to a heat carrier comprising at least one collector pipe (1) for receiving the ends of flat pipes (10a), especially for a CO² air conditioning unit for motor vehicles. The collector pipe (1) is formed by an open hollow profiled section (7) with edges (8, 9) forming a continuous longitudinal slit extending in a longitudinal direction and the ends of the flat pipes (10a), which are twisted at an angle of 90°, are received in a fluidically tight manner in the longitudinal slot. According to the invention, the edges (8,9) partially abut, forming a separating joint (4) and are partially rolled back, forming receiving openings for the ends of the flat pipes (10a). The receiving openings are produced by plastic deformation.

The invention relates to a heat exchanger with at least one header tube for the reception of flat tube ends, according to the preamble of patent claim 1, known from the applicant's DE-A-198 46 267. The invention relates, furthermore, to a method for the production of a heat exchanger, according to the preamble of patent claim 7.

The heat exchanger which has become known from the applicant's DE-A-198 46 267 has a header tube with a slot which runs in the longitudinal direction and which receives flat tube ends rotated through 90 degrees with respect to the flat tubes. In this case, the flat tube ends are arranged in mutual abutment, that is to say one behind the other without a gap in the longitudinal slot, and are soldered in a fluidtight manner to the header tube. Owing to this arrangement, the tube division, that is to say the distance between the flat tubes of this heat exchanger which are arranged parallel to one another is restricted, specifically to the depth of the flat tubes (extent in the air flow direction). As a result, the height of the ribs which are arranged between the flat tubes is also fixed. This means a restriction in the design of flat tube heat exchangers of this type which are intended particularly for CO2 air-conditioning systems for motor vehicles. The header tube for the known heat exchanger is produced either by cutting machining, for example by the milling of the longitudinal slot into a thick-walled tube, or by the bending round of a plane sheet metal strip. Since, in cutting machining, there is always the risk that chips remain on the workpiece and therefore subsequently infiltrate as impurities into the coolant circuit, noncutting manufacture is to be preferred. Since the pressures in CO2 air-conditioning systems are considerably higher than in conventional air-conditioning systems having the coolant R134a, the wall thickness of a header tube is relatively large, which does not make it any easier to machine or form the latter.

The object of the present invention is to improve a heat exchanger with a header tube of the type initially mentioned, to the effect that the header tube can be produced in a simple way, as far as possible leaves behind no impurities after the production process and is not subject to the restrictions mentioned in terms of the tube division. The object of the invention is also to describe an economical method for the production of the heat exchanger initially mentioned, in particular of its header tube.

The solution for achieving this object arises from the features of patent claims 1 and 8. The dependent claims relate to advantageous refinements and developments of the invention. According to the invention, the header tube has a continuous longitudinal seam or longitudinal slot which runs in the longitudinal direction and into which reception orifices for the flat tube ends are integrally formed at predetermined intervals. The header tube is therefore designed as an open hollow profile which is slotted in the longitudinal direction in which the edges of the longitudinal slot partially bear directly against one another and are soldered in this region and partially are deformed according to the contour of flat tube ends so as to form reception orifices. This affords the advantage that the tube division selected may be even greater than the depth of the flat tube, this being advantageous particularly in the dimensioning of gas coolers or condensers for a CO2 air-conditioning system.

According to an advantageous development, the reception orifices for the tube ends are produced by noncutting deformation, that is to say plastic deformation, thus entailing the advantage that no chips which would contaminate the coolant circuit are left behind. Moreover, this noncutting forming incurs lower costs.

According to an advantageous development of the invention, the edges of the slotted hollow profile are prolonged so as to form set-out edge strips, thus giving the header tube a higher strength, since the edge strips act in the manner of a reinforcing bead. If the edge strips are set out in a V-shaped manner, this results in an assembly-friendly introduction slope for the flat tube ends to be inserted. The edge strips may also be set out or angled in such a way that they lie in a common plane and thus form with the cross section of the header tube an omega shape. This increases the strength even more than a V-shaped set-out of the edge strips. In addition, when twisted flat tubes are used, the set-out edge strips constitute a limitation of the depth of insertion of the flat tubes.

By the method according to the invention, it is possible to produce the reception orifice for the flat tube ends by plastic deformation, using a simple wedge-shaped tool. First, a hollow profile slotted in the longitudinal direction is produced by bending round, so that the edges touch one another along a contact line in the region of the longitudinal slot and edge strips are set out in a V-shaped manner so as to form an introduction slope. This V-shaped set-out results in an advantageous introduction slope for the wedge-shaped tool which has the contour of the flat tube ends. With the hollow profile being supported at the same time by a die, this tool is driven into the longitudinal slot, the result of which is that the material of the hollow profile is displaced in the region of the wedge-shaped tool, that is to say the material flows into the adjacent regions. Since the wall thickness of the header tube is relatively large, there is sufficient thickness so that no material weakening occurs, on the contrary the opposite being achieved due to strain hardening. If the tool is appropriately fitted with a plurality of stamps (wedge-shaped tools), all the orifices can be produced in one operation or in steps in order to keep the degrees of deformation per operation lower. This also results in a higher surface quality of the reception orifices for the flat tube ends.

After the reception orifices are ready-calibrated, the flat tube ends are introduced, the edge strips set out in a V-like manner acting as an assembly-friendly introduction slope. The header tube is subsequently soldered to the inserted flat tube ends, the entire longitudinal slot of the hollow profile being soldered in a leaktight manner, this soldering taking place, together with the soldering of the entire heat exchanger including ribs, in a soldering furnace. So that sufficient solder flows into the solder gaps when the soldering temperature is reached, the hollow profile and/or the flat tube ends are solder-plated at least on one side, so that there is sufficient solder available for leaktight soldering. When extruded flat tubes which, as a rule, have no solder layer are used, there is sufficient solder available for leaktight soldering if, in particular, the hollow profile is solder-plated on the inside.

An exemplary embodiment of the invention is illustrated in the drawing and is described in more detail below. In the drawing:

FIG. 1 shows a header tube in a bottom view,

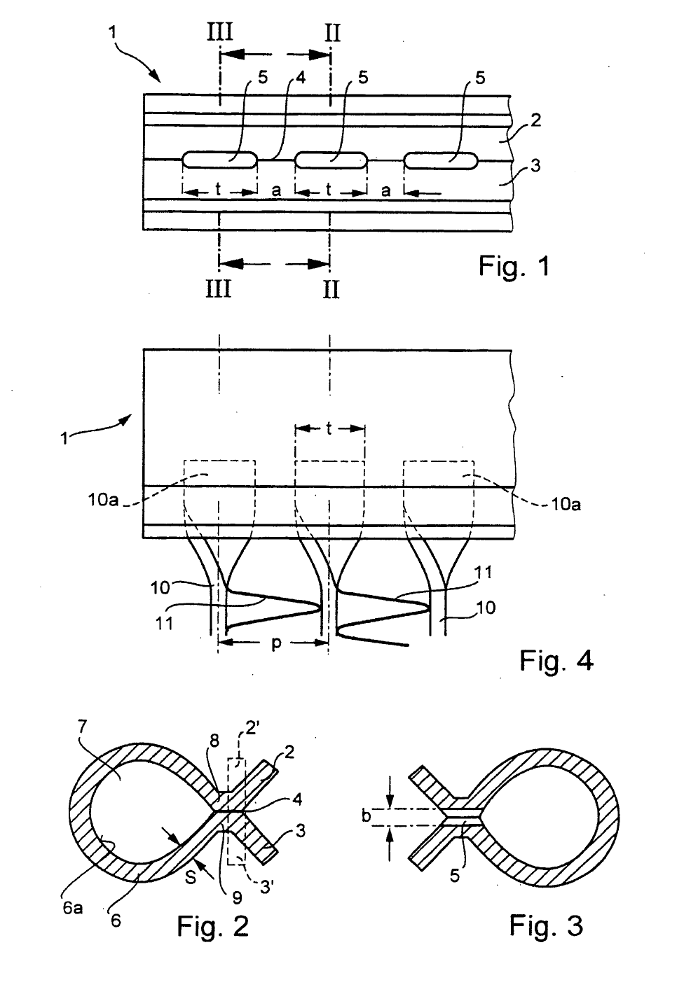

FIG. 2 shows a section through the header tube according to FIG. 1 in the plane II-II,

FIG. 3 shows a section through the header tube according to FIG. 1 in the plane III-III,

FIG. 4 shows a view of the header tube with flat tubes,

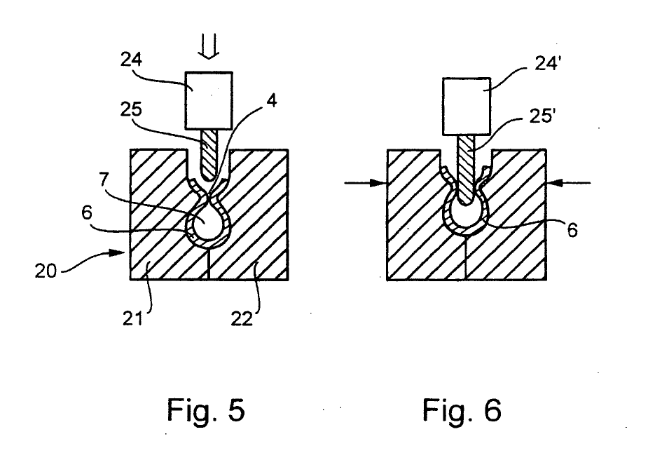

FIG. 5 shows a device for producing the header tube, and

FIG. 6 shows the device according to FIG. 5, with the stamp moved in.

FIG. 1 shows a header tube 1 for a heat exchanger of a CO2 air-conditioning system, not illustrated, for motor vehicles, specifically in a bottom view. The header tube 1, only partially illustrated, is a slotted hollow profile, the edge strips 2, 3 of which butt on one another at a common joint or parting point 4. In the region of this parting joint 4 running in the longitudinal direction are arranged reception orifices 5 which are designed in the manner of a long hole and which have a longitudinal extent t and a distance a from one another.

FIG. 2 shows a cross section through the header tube 1, specifically along the sectional plane II-II in FIG. 1, that is to say in the region of the parting joint 4. The header tube 1 is formed by bending round from a sheet metal strip 6 of wall thickness s so as to form a hollow profile 7, the convexly designed edges 8, 9 of which lie against one another and form the parting joint 4. The sheet metal strip 6 or the hollow profile 7 is prolonged beyond the edges 8, 9 and forms the edge strips 2, 3 set out in a V-shaped manner. In the illustration using broken lines, the edge strips 2′, 3′ are angled at right angles and with a hollow profile form a Q (omega).

FIG. 3 shows a section through the header tube 1 along the plane III-III in FIG. 1, that is to say through a reception orifice 5. This reception orifice 5 serves for the reception of flat tube ends, not illustrated here, and has a width b which corresponds to the width of the flat tubes. The production of these reception orifices 5 is described in more detail below.

FIG. 4 shows a view of the header tube 1 according to FIGS. 1 to 3, flat tubes 10 with corrugated ribs 11 arranged between them being illustrated here. The flat tubes 10 have flat tube ends 10a (illustrated by broken lines) which, as is known per se, are twisted through 90 degrees with respect to the flat tubes 10. These flat tube ends 10a are inserted into the reception orifices 5 illustrated in FIGS. 1 to 3 and are subsequently soldered to the header tube 1. The header tube 1 has on its inside 6a (cf. FIG. 2) a solder plating (not illustrated) which ensures a soldering of the flat tube ends 10a to the header tube 1 and of the edges 8, 9 in the region of the parting joint 4. As is known, the corrugated ribs 11 are soldered to the flat tubes 10. The entire heat exchanger, consisting of at least one header tube 1, of the flat tubes 10 and of the corrugated ribs 11, is soldered in one operation in a soldering furnace. The distance between the flat tubes 10 (from center line to center line), that is to say the tube division, is designated by p. It is markedly greater here than the depth t of the flat tubes 10 or of the flat tube ends 10a.

FIG. 5 shows a tool 20 consisting of two tool halves 21, 22 for producing reception orifices 5, that is to say a device for carrying out the method according to the invention. The hollow profile 7 is introduced into the tool 20 which has been moved together, the sheet metal strip 6 lying snugly with its outer contour against the die, that is to say said sheet metal strip is supported outwardly on all sides. As illustrated in FIG. 2, the edges 8, 9 touch one another in the region of the parting joint 4. Above the introduced hollow profile 7, the tool 20 has a continuous slot 23, in which a stamp 24 having a tool 25 tapering in a wedge-shaped manner is brought into position.

FIG. 6 shows the stamp in the moved-in position 24′, the wedge-shaped tool 25′ having penetrated into the parting joint 4 and at the same time having displaced the material of the sheet metal strip 6 out of the region of the parting joint 4 into the adjacent regions. In this case, a strain hardening of the material occurs at the same time. By the tool halves 21, 22 being firmly braced against one another, the outer contour of the sheet metal strip 6 is maintained and it cannot shift away from the penetrating tool 25′. A flow of the material on the inside of the sheet metal strip is thereby brought about. After the stamp 24, 25 has been withdrawn, not illustrated here, the shape illustrated in FIG. 3, that is to say with a reception orifice 5, is obtained. In addition, a stamp retention plate or a stamp guide plate (not illustrated) which lies on the tool halves 21, 22 may be provided, the stamp retention plate or the stamp guide plate ensuring the depth of the reception orifice 5 and the dimensional stability of the latter.

It would also be possible, as is not illustrated here, to have a two-stage or multistage method for shaping the reception orifices 5, that is to say by means of a two-stage or multistage tool.

1. A heat exchanger, with at least one header tube (1) for the reception of flat tube ends (10a), in particular for a CO2 air-conditioning system for motor vehicles, the header tube (1) being formed from an open hollow profile (7) with edges (8, 9) running in the longitudinal direction and forming a continuous longitudinal slot, and the flat tube ends (10a) being received in a fluidtight manner in the longitudinal slot, characterized in that the edges (8, 9) butt against one another in regions so as to form a parting joint (4) and are set back in regions so as to form reception orifices (5) for the flat tube ends (10a).

2. The heat exchanger as claimed in claim 1, characterized in that the reception orifices (5) are produced by the noncutting deformation of the edges (8, 9).

3. The heat exchanger as claimed in claim 2, characterized in that the deformation takes place by means of material displacement.

4. The heat exchanger as claimed in claim 1, characterized in that the edges (8, 9) are prolonged outward beyond the parting joint (4) and form set-out edge strips (2, 3).

5. The heat exchanger as claimed in claim 4, characterized in that the edge strips (2, 3) are set out in a V-like manner.

6. The heat exchanger as claimed in claim 4, characterized in that the cross section of the header tube (1) with edges (8, 9) and with edge strips (2′, 3′) corresponds to the shape of an omega (edge strips 2′, 3′ in a common plane).

7. The heat exchanger as claimed in claim 4, characterized in that the edge strips (2, 3) are designed as the limitation of a depth of insertion of twisted flat tube ends.

8. A method for the production of a heat exchanger as claimed in claim 1, characterized by the following method steps:
the initial material used is a plane sheet metal strip (6) with a relatively large thickness s and with rectilinear edges (8, 9),
the sheet metal strip (6) is deformed into an open hollow profile (7) with a longitudinal slot (4), the edges (8, 9) of the hollow profile (7) touching one another in the region of the longitudinal slot, and the edge strips (3, 4) being set out as an introduction slope,
the hollow profile (7) is received in a tool (20) and supported outwardly,
the reception orifices (5) are produced in the region of the longitudinal slot (4) by material displacement (plastic deformation) by means of the introduction of a wedge-shaped tool (25).

9. The method as claimed in claim 8, characterized in that the flat tube ends (10a) are introduced into the reception orifices (5), the hollow profile (7) being capable of springing open elastically, and in that the header tube (1) is soldered in a leaktight manner in the region of the longitudinal slot (4) between the flat tube ends (10a) and around the flat tube ends (10a).

10. The method as claimed in claim 8, characterized in that the sheet metal strip (6) and/or the flat tube end (10a) are solder-plated at least on one side.

11. The method as claimed in claim 8, characterized in that the sheet metal strip (6) and/or the flat tube end (10a) are solder-plated on both sides.
